(19) United States
(12) Patent Application Publication
(10) Pub. No.: US 2026/0098932 A1
(43) Pub. Date: Apr. 9, 2026

(54) DEVICE RANGING

(71) Applicant: Elliptic Laboratories ASA, Oslo (NO)

(72) Inventors: Espen KLOVNING, Strømmen (NO); Tom Øystein KAVLI, Oslo (NO); Ludvik LIDICKY, Oslo (NO); Ola Sandstad, Rælingen (NO); John Magne HELGESEN RØE, Sørumsand (NO); Edvard Severin Pettersen, Oslo (NO); Tobias BORÉN SVENDSEN, Oslo (NO)

(73) Assignee: Elliptic Laboratories ASA, Oslo (NO)

(21) Appl. No.: 19/120,738

(22) PCT Filed: Nov. 16, 2023
(86) PCT No.: PCT/NO2023/060092

§ 371 Date: Apr. 11, 2025

(30) Foreign Application Priority Data
Nov. 18, 2022 (NO) 20221247

(51) Int. Cl. G01S 5/18

(52) U.S. Cl. CPC G01S 5/18

(57) ABSTRACT

The present invention relates to a method for providing a distance measurement between a first and a second electronic devices and related system and devices here devices being connected to and being configured to communicate using wireless communication means. The method includes the steps of:—detecting a movement of the second device,—from the second device transmitting a request signal to the first device,—at the first device, receiving said request signal and generating a response signal using a first transducer,—receiving the response signal at the second device,—based on the response signal calculating the distance between the devices.

The present invention is based on calculating the absolute distance between a primary and secondary electronic device.

There are situations where users of electronic devices can take advantage of knowing the distance between two potentially mobile electronic devices at configurable, regular intervals or triggered by other mechanisms. Distance measurements can be used to initiate any number of different actions on one or both devices when the distance between them are at pre-configured distances. Alternatively, knowing the distance between devices may prevent or allow the devices to cooperate or communicate based on the distance between them.

Several different solutions have been proposed describing how two or more devices determine their relative positions and orientation based on ultrasound signals transmitted between the devices. With one speaker and two microphones on each device the positioning can be done in 2D like on a table surface. Radio communication (Bluetooth or WiFi) can be used to add communication capacity between devices and to give additional possibilities for device synchronization. In US2021/0400417 an audio system is described where different devices are able to determine relative positions and orientations.

EP1758308A1 refers to a system that provides a distance measurement between devices in a system at the activation by an acceleration sensor, where the distance measurement may use phase differences based on sound sensors. This is used for combining a synchronization signal and a sound.

Several methods are known for measuring the distance and/or relative positions, but they usually require an active sensor listening continuously for near-by devices as new devices may enter the vicinity or devices may be moved, changing the relative positions between the devices. This is power consuming, and it is an object of the present invention to provide a solution that minimizes the power consumption of the devices.

The objects of the present invention are achieved as described in the accompanying claims.

Thus, a solution is provided according to the invention being power efficient as it only detects the distance between devices and possibly the relative position when the devices is activated by an incidence that is related to a change in the distance, for example by registering that one of the devices have been moved using an inertia measuring unit or similar.

The present invention will be described more in detail below with reference to the accompanying drawings, illustrating the invention by way of examples.

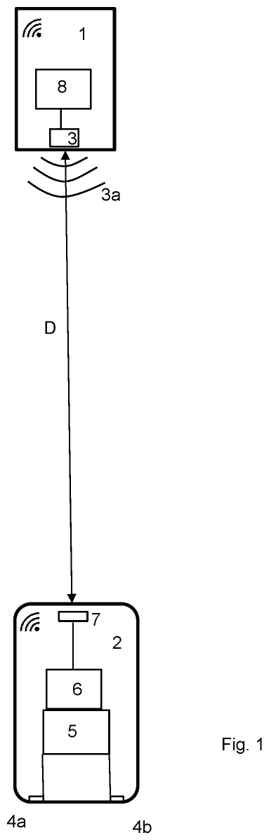

FIG. 1 illustrates two devices according to the invention.

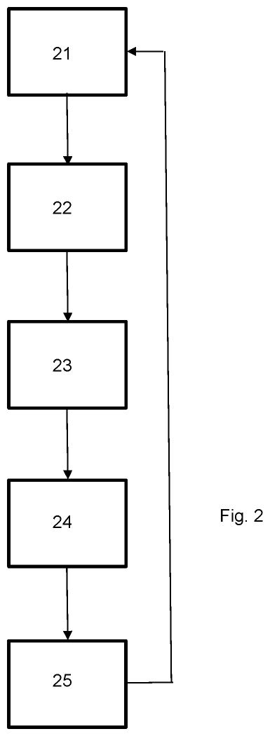

FIG. 2 illustrates the sequence of the method according to the invention.

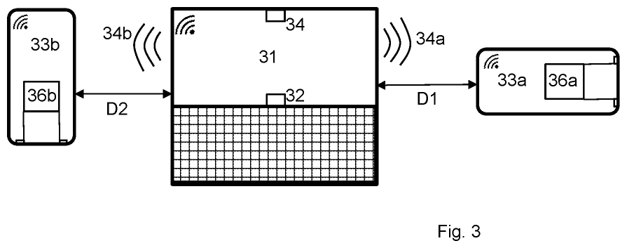

FIG. 3 illustrates a system according to the invention including a computer and two mobile devices.

FIG. 1 illustrates a first 1 and a second 2 device, both including being configured to communicate using WiFi or similar systems. The second device 2 also includes a sensor 6 having a low power consumption, such as an inertia measuring unit (IMU), connected to a main processor 5. In the drawing, the second device 2 is a mobile phone also including microphones 4a,4b and a speaker 7.

When the sensor 6 detects a movement indicating the need to update the distance, in which case the processor in the second device 2 transmits a request signal using the WiFi connection. Initially the movement may include activating a key or pressing a computer mouse or touch pad for initializing the system, but at a later stage the movement primarily includes activities assumed to change the relative position and orientation between the devices. The request signal is received by the processor 8 in the first device 1 which instructs a transducer 3 to transmit a response signal 3a to be received by the second device 2. According to the preferred embodiment of the invention the response signal is an acoustic, preferably ultrasound signal being received by at least one microphone 4a,4b in the first device. If the second device is provided with two microphones, the angle of the incoming signal can be analyzed, and the distance D and possibly relative position of the devices can be calculated, e.g. as described in NO20221246.

The WiFi connection may be established if the distance is within predetermined limits, e.g. being within a predetermined zone around the first device and/or if other requirements are met such as protocol type, signal strength etc. For example a computer mouse may requesting paring using Bluetooth if the distance, position and orientation is within predetermined limits, e.g. giving priority to a mouse configured for right hand use placed on the right side and within a practical distance from a computer.

Referring to FIG. 2 the sequence of the operation may thus be:
21 Detecting a movement in a second device using a sensor 6 with a low power consumption, e.g. an IMU.
22 In the second device 2 transmitting a request signal using a wireless communication system such as WiFi, Bluetooth, etc.
23 Receiving, in a first device 1, the request signal
24 Generating from the first device a response signal, preferably and acoustic signal in the ultrasound range.
25 Receiving, the second device, the response signal and calculating the distance between the devices.

When the distance has been calculated the system may wait for the detection of another movement, or continue repeating the process as long as a movement is registered. The distance information may be distributed in the system, e.g. using WiFi so that the first device may adapt to the distance between the devices.

If the direction between the devices is known or already measured, e.g. as disclosed in and the IMU is capable of measuring the direction of the movement the process may only start when the movement is in the direction between the devices, thus changing the distance.

FIG. 3 illustrates a situation where the first device is a computer and two second devices 33a,33b are present, each including circuitry 36a,36b detecting movements and transmitting request signals to the first device 31, which responds by transmitting response signal 34a,34b. The request signals should preferably include an identification code so that the first device may adapt the communication between the devices to the distance and possibly to the orientation and relative positions. It is also possible to have two first devices in a system. If several first devices, with relative positions that are known or measured, are present the mobile device may select the first device by registering the movement or orientation of the mobile device, e.g. as described in NO20221243. As an example the first device may be a computer related to a videoconferencing system allowing an access, possibly limited, for the secondary devices to join and present files in the system, creating an ad-hoc network,

As stated above there are different ways of measuring distance between electronic devices. Transponding using ultrasound is one viable technique that allows an electronic device to measure the distance between itself and another electronic device. In this case, both the electronic devices require at least one ultrasound transducer to transmit an ultrasound signal (e.g. chirp) towards the other electronic device at time To and at least one ultrasound transducer in the other device to receive the ultrasound signal by receiving the transmitted signal at time T₁. When the second device receives the ultrasound signal from the first device, it will send an ultrasound signal back to the first device again using the same or another ultrasonic transducer. The first device will receive the ultrasound response signal in the same or another ultrasound transducer at T₂ and based on the speed of sound and the elapsed time since transmitting the first ultrasound signal (i.e. T₂-T₀), calculate the distance between the devices. The second device may delay the response with its own ultrasound signal with a predefined delay D known to both the first and second device making the second device adjust the distance measurement using the elapsed time T₂-D-T₀when calculating the distance as discussed above.

In most cases, it will be an advantage whether the first and second device can simultaneously communicate either simplex or duplex using another wireless technology such as Bluetooth or WIFI. This communication channel could be replaced with a low bit-rate acoustic communication channel based on modulation of an acoustic waves if no other option is viable.

One alternative to transponding is to synchronize the clocks of the first and second device to within a required specification in order to provide distance measurements with the required accuracy. Synchronization protocols like Network Time Protocol or Precision Time Protocol can be used if or when the devices are part of the same data network. One clear benefit of relying on clock synchronization is that the second device does not have to send any ultrasound signal back to the first device. The elapsed time T₁-T₀ between the first device transmitting the ultrasound signal to the second device and the second device receiving the ultrasound signal can be used to calculate the distance between the devices in the second device. If the clocks of the devices are synchronized, the distance measurement can be done by the first device sending the ultrasound signal at least once at a predefined time. The ultrasound signal can be sent only once or at predefined intervals known to both devices to enable the second device to calculate the distance a) from the elapsed time and b) the speed of sound. It is also possible for the first device to send the timestamp of when the ultrasound signal will either be sent or have been sent in a separate out-out-band data channel to the second device. The information can also be sent using an in-band ultrasound modulation technique if the out-of-band channel is not available.

A third option is to send a radio signal and the ultrasound signal at the same time and measure the time difference when these signals are received. The radio signal will travel at speed of light. Another possible technique is to send a wireless signal (e.g. wifi, Bluetooth, Zigby, etc) at the same time as the ultrasound signal and measure the time difference between when the radio signal and the ultrasound signal arrived in the second device. The time difference and the speed of sound can be used to calculate the distance between the two devices.

Another possible technique is to utilize the difference in speed of sound at different frequencies e.g. as described in https://pages.mtu.edu/˜suits/SpeedofSound.html, By using an acoustic signal that includes both an infrasound and ultrasound component, reception of different components of the signal using a sampling rate capable of detecting the differences in acoustic speed can be used to estimate the distance between the first and second device based on known in-air speed differences.

A fifth option is to use signal amplitude of the received signal as an approximation on distance to the other device based on empirical data. This is only viable if ultrasound transducer of the first device transmitting the output signal is not covered or wrapped by one or more objects but is transmitting the output signal in the same space where the second device is located. Combining the amplitude information with other pieces of information (e.g. device orientation) or techniques as discussed above can provide additional information. At the same, using empirical data could enable the second device to know that the first device is covered or wrapped by one or more objects possibly reducing the signal output and reach. A wide range of electronic devices today have numerous sensors including 6DoF inertial measurement unit sensors (IMU). These sensors can be used to detect the device orientation which again may be used to select the ideal set of ultrasound transceivers (e.g. microphones facing the first device) for receiving or sending an ultrasound signal from/to the first device.

If one or both devices are moving away from the other devices, the distance measurement will change as the devices move away from each other and therefore be less accurate or already obsolete when the measurement is done. One way of adjusting the distance measurement is to include doppler measurements of the incoming ultrasound signal and adjust the calculated distance measurements with a movement offset predicted by the doppler information in the received ultrasound signal as is discussed in NO20221244.

As stated above continuous distance measurements using acoustic and in some cases radio signals as outlined above may not be practical due to power constraints of the electronic devices or interference in the frequency bands in use. Duty-cycling the distance measurements at fixed or pre-defined intervals, may be necessary in some situations. The devices can also agree on using pseudo-random intervals based on an agreed upon random seed for intervals used in the distance measurements to reduce the chance of interference from other devices doing measurements in the same area.

The objects of the present invention may be solved using IMU sensors to only trigger distance measurements when absolutely needed. The power consumption of IMU sensors is generally lower than acoustic sensors.

Thus, according to the preferred embodiment of the invention an IMU sensor in either the first device or the second device detecting significant lateral movement could trigger a new set of distance measurements since the last distance measurement may be invalid after the device has moved or is still moving. While at least one of the devices are still moving, the distance measurements should continue. Once the IMU sensor indicates that the movement has stopped, the distance measurements can stop once the distance to the device has been measured again. If the devices are mounted in a moving vehicle or object (e.g. train, boat, etc), the IMU sensor data between the two devices may have to be compared to decide whether the devices are moving relative to each other or not. If they are, a new set of distance measurements are needed.

Another mechanism to prevent unnecessary distance measurements is if the first device sends out regular wireless beacons with a limited range that the second device can detect if it is close enough. Thus, if the second device cannot hear the beacons from the first device, distance measurements are not necessary. Similarly, the first device could set up a geofencing zone using for example GPS technology around the device where the second device could use its own GPS device if available to limit the distance measurements to situations where it is inside the geofencing zone established by the first device.

Another possible solution if the first device is stationary but the second device is mobile, is to use low-power environmental sensors (e.g. temperature sensor, humidity, air quality, atmosphere, etc) in the second device, if available, to decide when the second device is potentially close to the first device. The first and second device can exchange historical sensor data whenever a suitable communication channel is available to allow the second device to enter a power saving mode when the current environment indicates that the second device is not in the same environment as the first device based on historical data or a DNN based on historical data. The system may be capable of detecting presence of objects or persons in the vicinity and limit the sensor activity based on the type of activity measured.

Another solution would be to send out an identifiable ultrasound signal from the first device if the power constraints of the device allow it. This is possible if the first device is a stationary device connected to a power source. The idea is that the second device will listen for the ultrasound signal sent out by the first device and start the distance measurement process when the signal is detected.

If one of the ultrasound signals that are emitted from the first device is a sine or set of sines while the second device starts to move away from the first device, the second device can use changes in the sine frequency or frequencies to estimate both the speed and based on integration, the change in distance of the second device moving away from the first device. These estimates can be compared to estimates of device speed and corresponding distance moved from IMU sensor data. The estimates of both data sources may provide more accurate information on the path the second device relative to the first device, for example as described in NO20221244.

In some situations where one of the devices is mobile (e.g. carried, worn, attached to a person or an animal etc) while the other is stationary, the current relative speed of the mobile device relative to the other device and the changing relative distance between devices may be used to deduce user intent of the relative movement. Combining distance measurements with estimated instantaneous speed of the mobile device based on IMU data and doppler effects on the emitted sine signal(s), allows the mobile device make judgement on where the user is heading and what action to take based on that.

In scenarios with more than one first device in a limited area where a second device can receive the ultrasound signal from multiple first devices simultaneously, the ultrasound signal emitted from each first device should preferably be unique. With a unique signal, the second device could easily detect that it is in range of the correct first device. However, the ultrasound frequency band is limited, and it is not practical to create a unique signal for each first device that will be unaffected by for example interference from signals emitted from other first devices. It is possible to create a fixed number of unique signals using known multiplexing techniques such as FDM (Frequency-division multiplexing), TDM (Time-division multiplexing), CDM (Code-Division Multiplexing) and SDM (Space-division multiplexing). It is possible to set aside a frequency band with a fixed number of different frequencies where each first device is emitting a signal with an assigned frequency. If there are more first devices than available frequencies given that the usable frequencies need to be separated in frequency (e.g. 150 Hz) to avoid that the doppler effect of a moving second device leads to incorrect frequency detection, several first devices could send out TDM sine pulse with limited duration (e.g. 100 ms) using the same frequency.

Another approach utilizing CDM would be to let different first devices to send out a concurrent set of sine pulse to create different sine frequency codes. In this case, the second devices must know the frequency code used by its own first device and be capable of handling situations where one or more of the sine pulses may collide with sine pulses emitted by one or more other first devices. If the first device cannot be uniquely detected using the ultrasound signal it emits, the second device may use a handshake mechanism between the first and second device to make sure that the detected first device is the correct one. The second and first device may have predefined ultrasound signals to send to each other in a two-way handshake. In principle, the second device will send a coded ultrasound signal (e.g. modulated message, sine pulses with one more sines from a non-overlapping frequency range, chirps, coded signals, etc) to the first device. Once the first device recognizes the coded message, it can send another coded ultrasound signal to the second device. If the random seeds of the pseudo-random algorithm are the same, the generated coded messages are picked at random while the first and second device have an active communication channel, the probability that another first device will be capable of completing the two-way handshake correctly drops significantly.

Although modulating a message over ultrasound could potentially secure the authentication, the data rate of an ultrasound modem is too low to be used for this purpose. Thus, as soon as the two-way handshake has been completed correctly, the second device can be almost certain that it is communicating with the correct first device and the distance measurements can begin. The first and second device pair could use a pre-arranged pseudo-random sequence known to both devices to generate an ever change set of coded messages to prevent eavesdroppers from replaying older messages.

In devices that have strict power requirements, using a low-frequency ultrasound signal (e.g. 20-24 kHz if the sampling rate is 48 kHz) and therefore use the minimum sampling rate suitable only for the lowest frequency, could lower the power consumption. If one of the sine frequencies used by a first device can be detected using a lower sampling rate then the rest of the sine frequencies, the second device could potentially use the lower sampling rate until it detects the sine frequency or sine pulse used by its first device, and then change to a higher sampling rate to properly sample the other frequencies of the signal emitted by the first device when the next ultrasound signal is received. Switching the sampling rate after an initial detection or not would typically be a compromise between detection response and power consumption.

If the first device is a stationary device but the second device is a mobile device, the second device could monitor its surroundings when moving around and create an internal map of the surroundings around the first device. As an example, the mobile second device could register any device (e.g. WIFI Access Points, Bluetooth devices, noise sources, ultrasound device, etc) or physical layout (i.e. stairs, elevators, etc) it detects while moving around when the first device is out of reach using the distance schemes discussed above. The second device should also register relevant sensor events from the second device such as IMU sensors, step counters, door sensors, humidity sensors, ALS sensors, altimeter, time-of-day, etc. Similarly, the second device can register any device it can detect (i.e. WIFI AP, BT device, noise source, ultrasound device) and relevant sensors such as IMU sensors, ALS sensors, step counters, altimeter, etc when the first device is within reach. This information can be used to create an overview of locations where the first device is reachable.

The information can be added to an Edge Al training process in one or both of the first and second devices where the detected devices, sensor information and time of day information etc are used as input. The updated ML model could be transferred to the second device whenever a suitable communication channel between the first and second device is available. Once the second device has gotten the updated Deep Neural Network model, the events from sensors and the environment can be used as input features to the DNN inference engine making a probabilistic decision whether the first device is likely reachable from the current location of the second device or not. As an example, if the mobile second device is mobile and temporarily not capable of transferring data to the first device, it can transfer the information to the first device whenever it has an established communication channel to the first device again. This is relevant in scenarios where the second device may run in a low power state where all networking capabilities are temporarily disabled (i.e. a Windows laptop in the Modern Standby power state), the data it gathers can be transferred to the first device as soon as the power state of the second device is changed and the networking capabilities are re-enabled and the communication channel is available again.

In some scenarios, there may be several first devices located in close proximity to each other in open environments, e.g. office buildings, cubicle environments, etc but a particular second device should only measure the distance to one specific of these first devices. Since there may be more than one first device in close proximity, the second device needs to make sure that it measures the distance to the correct first device.

One possible solution is that every first device emits a coded ultrasound signal detectable in an ultrasound detection zone around the first device. The size of the zone depends on the amplitude of the coded signal (i.e. chirp, one or more sines, one or more sine pulses, etc) and the distortion it will experience. A typical zone would be up to 10-15 meters in diameter in an open space. Obstructions such as walls etc may reduce the size of the ultrasound zone notably.

Emitting a coded ultrasound signal from a first device enables a corresponding second device to identify its first device when it can detect the coded ultrasound signal.

This is important if the power consumption of the second device should be minimized. One possibility is that the second device and first device communicate using data modulation (e.g. FSK, PSK, etc) with ultrasound signals. Another option is to send the data between the devices on an out-of-band communication channel (e.g. WIFI, Bluetooth, etc) if available. In some cases, the out-of-band communication channel may have to be re-established by the second and/or first device first to enable the out-of-band communication.

In one embodiment, the first device is a video conferencing device that wants to know the distance to all the laptops in the same room. In this case, the first device would use transponding where the second device will respond to the signal from the first device with a delayed response signal sent back to the first device from the second device. When the first device receives the response and adjusts for the agreed upon transponding delay, the first device could calculate the distance to second device. If needed, the information about the second device could be transmitted from the first device to the second device either as in-band information embedded in the signal from the first to the second device or as information in an out-of-band signal using any available wireless or optical communication technology.

In one embodiment, the first device is a gaming device that wants to know the distance to all the game controllers in the same room. In this case, the first device would transmit a radio signal at the same time it transmits the ultrasound signal. When the second device receives these signals and measures the time difference of reception, it can calculate the distance to the first device. When the first device receives the response and adjusts for the agreed-upon transponding delay, the first device could calculate the distance to second device. If needed, the information about the second device could be transmitted from the first device to the second device either as in-band information embedded in the signal from the first to the second device or as information in an out-of-band signal using any available communication technology.

In another embodiment, the first device is a door access system that will display different access panel menus depending on how far away the personal access device is. In this embodiment, both the first and second devices are synchronizing their clocks with any known, high-accuracy synchronization protocol (e.g. NTP, PTP, etc) The first device will send out an ultrasound signal at a predefined start time and it will be received by the second device that can then calculate the distance between the first and second device.

In another embodiment, the video conferencing system wants to know the distance to the mobile device (e.g. smartphone) that controls the conferencing system at the moment. It allows the video conferencing system keep track of how far the mobile device is currently. This may be beneficial if the mobile device leaves the room and the video conferencing system wants to regain the control.

In yet another embodiment of the invention, when the secondary device comes closer to the primary device than a preconfigured distance threshold, either device may connect to the other device via a wireless technology including WiFi, Bluetooth, etc to enable the two devices to communicate. There may be additional conditions that must be fulfilled before the connection is set up including device state, device configuration (hinge angle, folded, unfolded, screen detached, lid closed etc), device orientation, power state, biometric security such as but not limited to face-id, speech recognition, fingerprint, etc. Gestures, that is, how either or both devices are handled (e.g. shaking, lifting, waving, etc) could be yet another condition that must be fulfilled for the connection to be initiated. Other conditions may include not only the distance between the devices but also the relative position between the devices based on techniques discussed in NO20221246 and NO20221243. The secondary device may need to be in a predefined position relative to the primary device e.g. to the right of, left of, below, in front of, on top of the primary device, before the connection is initiated. Another solution is to monitor the surroundings using presence sensing solutions including acoustic solutions to prevent the connection from being initiated if other users are close by. Combining a set of the conditions may also be a possible solution enabling the user to control when the connection is initiated.

A user may for security reasons have to approve connection setup with at least one biometric scheme (e.g. fingerprint, speech recognition, face-ID) or an approval dialog on either or both devices.

According to yet another embodiment one of the devices to be connected is a wireless access point may include an audio system with an output device capable of transmitting ultrasound messages to device in the proximity of the access point. Since the ultrasound messages for all practical purposes are constrained within the room where the access point is transmitting by physical properties of ultrasound, the ultrasound messages can include information about how to connect to the wireless network handled by the wireless access point.

The messages can include the SSID and corresponding password information enabling the recipients of the ultrasound message to connect to the wireless network seamlessly. Even though the information extracted from the ultrasound messages are not used for automatically connecting to the wireless network, these ultrasound message can also be used to filter out all the wireless access points that are outside the room. Unless the ultrasound message corresponding to a specific wireless access point is not heard, the device can filter out wireless access points in other rooms from the list of available networks.

In another scenario with small cellular base stations (e.g. femtocells) targeted for homes and small businesses, transmitting ultrasound from the cellular base station (CBS) will enable the User Equipment (UE) to filter out all the CBS′ outside the space or room where the UE currently resides. In an apartment building where multiple CBS's have been installed, it can be a problem for a UE to select the preferred CBS. If the CBS can transmit ultrasound messages and the UE can receive them, the messages can be used by the UE to connect to the CBS in the same room, and not the CBS with for example the highest signal strength. The ultrasound message may include additional information about the cellular network including cost, QoS parameters, etc that will allow the UE to make an informed decision whether it should connect via the CBS or not. It is also possible that the UE and CBS exchange multiple ultrasound messages. The messages can be used to send secured messages between the devices to verify that the UE is allowed to connect to the CBS. The messages can also be used to measure the distance between devices as described above. Based on these distance measurements, the either UE or CBS may disallow the UE to connect to the cellular network via the CBS. There may be other conditions too that will control when or if the UE is allowed to connect to the CBS.

Filtering out devices based on proximity can be more important for Bluetooth devices (e.g. Smart Speakers, cars, laptops, etc). Bluetooth devices further away.

To summarize the present invention relates to a system for monitoring the relative position between at least two electronic devices including wireless communication means, wherein a first of said devices includes a at least one first transducer unit configured to receive a predetermined request signal and a second device including a movement sensor and a at least one second transducer unit configured to transmit the predetermined request signal to be received by said first transducer unit, wherein the first device is configured to at the receipt of said request signal to initiate a communication between them suitable to measure the distance between the devices where a response signal is transmitted to the second device.

The signals may be encoded or have characteristics being suitable for calculating the distance between the devices.

Preferably the transducer units include acoustic transducers for transmitting and receiving acoustic signals, the distance being calculated based on the propagation time and/or the amplitude of the signal. The distance may be calculated in the processor of the second device or the necessary information is communicated to the first device for processing where the communication includes the result of measuring the propagation time of an acoustic signal between the first and second transducer unit.

Preferably the first and second communication units also include electromagnetic communication providing synchronizing the devices, the propagation time being measured from one of the devices to the other.

According to another embodiment the second transducer unit is configured to transmit a second acoustic signal after a predetermined time, the first transducer unit being configured to receive the signal from the second acoustic signal, the first device being configured to measure the distance between the devices based on the measured time from the first acoustic transmission.

The communication means of the devices may include an electromagnetic transmitter and receiver configured to detect signals from a device. The system may be configured to transmit the request signal only if another suitable device is detected in the system.

The second of the devices according to the invention will include a wireless communication unit for communication with at least one other electronic device, a transducer unit for receiving a predetermined signal and a movement sensor. The communication unit, transducer unit and sensor are connected to a main processor configured to, at the detection of a movement, initiate the transmission of a request signal and at the receipt of the predetermined signal at the transducer unit calculate the distance to said other electronic device. As stated above the predetermined signal is preferably an acoustic signal, the distance being calculated based on the propagation time or amplitude of the received acoustic signal.

The first electronic device also includes a wireless communication unit for communication with at least one other electronic device, and a transducer unit for transmitting a predetermined signal. The communication unit and transducer unit are connected to a processor. When the processor receives a request signal according to predetermined protocol or specifications through the wireless communication system it is configured to transmit through the transducer unit the predetermined response signal. Through the communication system the processor may be configured to receive a signal indicating the distance to the other device.

The method according to the invention for providing a distance measurement between a first and a second electronic devices being connected to and being configured to communicate using wireless communication means. The method includes the steps of:
detecting a movement of the second device,
from the second device transmitting a request signal to the first device,
at the first device, receiving said request signal and generating a response signal using a first transducer,
receiving the response signal at the second device,
based on the response signal calculating the distance between the devices.

The method may also include the steps of calculating the distance based on the propagation time and/or the amplitude of the acoustic signal, and the additional steps of determining if the distance is within predetermined limits and establishing a wireless communication if predetermined requirements are met, the requirements including that the distance are within the predetermined limits.

1-13. (canceled)

14. A system for monitoring the relative position between at least two electronic devices comprising wireless communication means, wherein a first of the devices comprises at least one first transducer unit configured to receive a predetermined request signal and a second device comprising a movement sensor configured to measure the direction of the movement and at least one second transducer unit configured to transmit the predetermined request signal to be received by the first transducer unit, wherein both devices comprise acoustic transducers, the first device is configured to at the receipt of the request signal to initiate an acoustic communication between the devices suitable to measure the relative position and orientation between the devices based on the acoustic communication.

15. The system according to claim 14, wherein the devices are configured to establish a wireless communication if predetermined requirements are met, the requirements comprising the distance and the direction of movement are within predetermined limits.

16. The system according to claim 14, wherein after the communication suitable to measure the distance is based in signal transmitted at pseudo-random intervals based on an agreed upon random seed.

17. The system according to claim 14, wherein the system is configured to, when the first device has recognized the request signal, can send another coded ultrasound signal to the second device, comprising a seed of pseudo-random algorithm thus enabling the devices to pick up signals at random intervals while the first and second device have an active communication channel.

18. The system according to claim 14, wherein the communication comprises measuring the propagation time of an acoustic signal between the first and second transducer unit.

19. The system according to claim 18, wherein the first and second transducer units also comprise electromagnetic communication means synchronizing the devices, the propagation time being measured from one of the devices to the other.

20. The system according to claim 18, wherein the second transducer unit is configured to transmit a second acoustic signal after a predetermined time, the first transducer unit being configured to receive the signal from the second acoustic signal, the first device being configured to measure the distance between the devices based on the measured time from the first acoustic transmission.

21. The system according to claim 14, wherein the devices comprise an electromagnetic transmitter and receiver configured to detect signals from a device, the system being configured to transmit the initiation signal only if another device is detected.

22. The system according to claim 14, wherein the relative direction between the devices is known and the direction of movement corresponds to the direction from the second to the first device.

23. An electronic device comprising a wireless communication unit for communication with at least one other electronic device, a transducer unit for receiving a predetermined acoustic signal and a movement sensor, the communication unit, transducer unit and sensor being connected to a main processor configured to, at the detection of a movement in a predetermined direction, initiate the transmission of a request signal and at the receipt of the predetermined signal at the transducer unit calculate the relative position and orientation between the devices.

24. The electronic device according to claim 23, wherein the predetermined signal is an acoustic signal, the distance being calculated based on the propagation time or amplitude of the received acoustic signal.

25. An electronic device comprising a wireless communication unit for communication with at least one other electronic device and a transducer unit for transmitting a predetermined acoustic signal, the communication unit and transducer unit being connected to a processor, wherein the processor at the receipt of a request signal through wireless communication, is configured to transmit through the transducer unit the predetermined signal, the processor being configured to receive a signal indicating the relative position and orientation between the devices.

26. A method for providing a distance measurement between a first and a second electronic devices, the devices being connected to and being configured to communicate using wireless communication means, the method comprising the steps of:
detecting a movement and direction of movement of the second device;
from the second device transmitting a request signal to the first device;
at the first device, receiving the request signal and generating an acoustic response signal using a first transducer;
receiving the response signal at the second device; and
based on the response signal calculating the relative position, direction and orientation between the devices.

27. The method according to claim 26, wherein the response signal is an acoustic signal and the distance is calculated based on the propagation time and/or the amplitude of the acoustic signal.

28. The method according to claim 26, comprising the additional steps of determining if the distance is within predetermined limits and establishing a wireless communication if predetermined requirements are met, the requirements comprising that the distance are within the predetermined limits.
